(19) United States
(12) Patent Application Publication
(10) Pub. No.: US 2013/0213838 A1
(43) Pub. Date: Aug. 22, 2013

(54) ADJUSTABLE HOLDER FOR TABLET COMPUTER AND COVER THEREFOR

(71) Applicants: Louis Hsuante TSAI, Huntington, NY (US); Jon DAVIES, Riverhead, NY (US)

(72) Inventors: Louis Hsuante TSAI, Huntington, NY (US); Jon DAVIES, Riverhead, NY (US)

(21) Appl. No.: 13/735,583

(22) Filed: Jan. 7, 2013

Related U.S. Application Data
(60) Provisional application No. 61/583,994, filed on Jan. 6, 2012.

(51) Int. Cl. G06F 1/16

(52) U.S. Cl. CPC G06F 1/1633
USPC 206/320

(57) ABSTRACT

A holder for electronic devices such as tablet computers is disclosed, the holder being made of a semi-stiff board (i.e., “PE” board or the like), covered by a soft fabric, vinyl, leather or the like. The holder includes four corner gripping devices which have a unique dimension and configuration which facilitates gripping each respective of a generally rectangular shaped electronic device for snugly retaining the device. Each corner gripping device is attached to an elastic band which may be woven or knitted. The holder is in turn attached, preferably by stitching to a foldable cover in a manner which permits the holder to pivot with respect to the cover so as to prop the holder view, of the electronic device.

### CLAIM OF PRIORITY

The present invention claims the benefit of priority from U.S. Provisional Application No. 61/583,994 filed on Jan. 6, 2012, and incorporated herein by reference.

### FIELD OF THE INVENTION

The invention relates to an adjustable holder and cover for a tablet computer. In particular, the inventive device is configured and dimensioned for retaining a tablet-type computer or other electronic reading device in a secure position for storage, travel and viewing by the user.

### BACKGROUND OF THE DISCLOSURE

In recent years a great number of electronic devices such as cell phones, tablet computers, eReaders and the like have become available to the consuming public in various sizes and shapes. In particular, such devices are marketed under various trademarks such as Ipad® tablets, Nook®, Kindle®, and other assorted known-type eReaders®. As such electronic devices have become readily available to the public, the need for securing such devices in a safe enclosure available for ready use has become increasingly important. In addition, the need for such enclosures which can provide means to position the devices of various sizes and thicknesses for ready viewing has also become desirable.

Because such devices are generally available in different sizes, it is generally known that each holder or cover must be particularly dimensioned to retain a particular size device. For example, such devices are often dimensioned according to the size of the screen and in most cases, the diagonal dimension of the screen extends between about 5 and about 12 inches.

Accordingly, the need for a holder and protective cover which can readily accept such devices in various sizes and thicknesses has become quite evident.

The present invention is directed to a holder and cover particularly constructed to snugly retain such electronic tablet-type computer devices within a protective cover, while making available the ability to prop up the device for ready viewing by the user.

### SUMMARY OF THE DISCLOSURE

A holder for electronic devices such as tablet computers is disclosed, the holder being made of a semi-stiff board (i.e., “PE” board or the like), covered by a soft fabric, vinyl, leather or the like. The holder includes four corner gripping devices which have a unique dimension and configuration which facilitates gripping each respective corner of a generally rectangular shaped electronic device for snugly retaining the device. Each corner gripping device is attached to an elastic band which may be woven or knitted. The holder is in turn attached, preferably by stitching to a foldable cover in a manner which permits the holder to pivot with respect to the cover so as to prop the holder up view, of the electronic device.

The holder uniquely and securely retains the electronic devices of several dimensions and thicknesses, while the foldable cover provides protection during transit and storage.

An embodiment of the present invention includes a cover member; a mobile device holding member attached to the cover member at least at one point of a rear face of the mobile device holding member; a plurality of gripping devices configured to engage each corner of the tablet mobile device respectively; and a plurality of elastic straps, each elastic strap joined to a respective gripping device and at least one end attached to a center area of the mobile device holding member.

### BRIEF DESCRIPTION OF THE DRAWINGS

These and other features, aspects, and advantages of the present invention will become better understood with regard to the following description, appended claims, and accompanying drawings wherein:

FIG. 1 is a top plan view of a holder and cover according to the invention, incorporating the hook-like cover gripping devices of the embodiment of FIGS. 9-11, and illustrating the debossed impressions in the cover which facilitate retention of the holder in an upstanding position by insertion of the left side edge of the holder into one of a selected impression when the cover is positioned flat on a horizontal surface and the holder is positioned upright;

FIG. 2 is a sketch of a top plan view of the holder of FIG. 1, illustrating the adjustable feature of the cover gripping devices made possible by elastic bands respectively connecting each gripping device to a center piece;

FIG. 3 is an illustration of a top plan view of the holder of FIG. 2, securing a device such as a tablet computer or the like in position, the device being about 8.9 inch screen size;

FIG. 4 is a view similar to FIG. 3, illustrating the holder of FIG. 2 securing a device being about 9.7 inch screen;

FIGS. 5-13 are perspective views which respectively illustrate the corner gripping devices of the embodiment of FIG. 1, and illustrating the visibility and utility of such gripping devices which make it possible to secure devices such as tablet computers of various thicknesses without need to change the gripping devices;

FIG. 14 is a perspective view of a holder according to the invention, incorporating alternative corner gripping devices having an inverted U-shape and being slideably positioned in a pair of parallel grooves in the upper layer of the holder, each said gripping device is attached to an elastic member which is in turn attached to a center piece as shown by the dash lines to permit gripping electronic devices of various dimensions;

FIG. 15 is a perspective view from above, of the holder and cover of FIG. 14, partially closed, but open sufficiently to show the construction details of the invention;

FIG. 16 is a perspective view of an embodiment of the present invention; and

FIG. 17 is a perspective view of an embodiment of the present invention.

### DETAILED DESCRIPTION OF DISCLOSURE

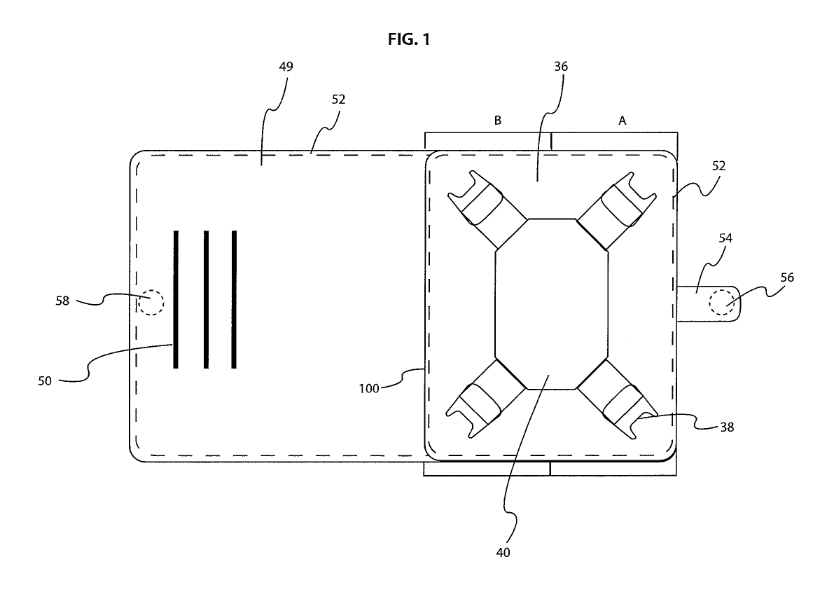

FIG. 1 is a top plan view of the holder 36 and cover 49, showing an exemplar construction and materials of construction. Debossed impressions 50 are shown. In particular, the holder 36 is constructed of a well-known “PE” board (or other suitable board) covered by a layer of vinyl, leather, fabric or the like, and stitched to the cover of like material by stitches 52. A closure latch 54 is made of a like material and can enclose a magnet 56 embedded therein, which is attractive to a magnet 58 of appropriate opposite field positioned on the opposite side of cover 49. Alternatively, snap latches can be used for closure of the cover.

The holder 36 is stitched or otherwise attached to the cover 49 at only a portion of the holder 36 identified by bracket A. The portion identified by bracket B is unattached to the cover 49 and thus allows the holder 36 to bend at the interface between bracket A and bracket B. Thus, the lower edge 100 of the holder 36 can be positioned to rest against one of the debossed impressions 50 formed on the cover 49. In this configuration, the tablet held in the holder 36 is positioned in an upright viewing orientation.

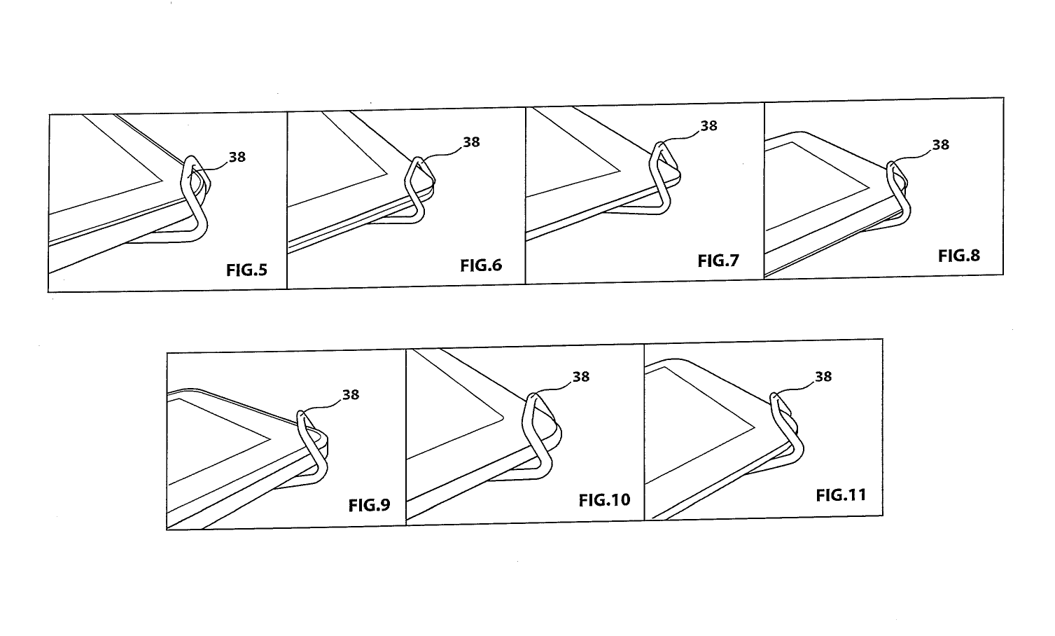

FIG. 2 is a top plan view of the holder 36 of FIG. 1, illustrating the corner clip-type gripping devices 38 respectively attached to center piece 40 by elastic bands 42, 44, 46, 48. As shown in FIGS. 2 and 5-11, the gripping devices are shaped as raised loops configured to encircle each respective corner of a tablet device.

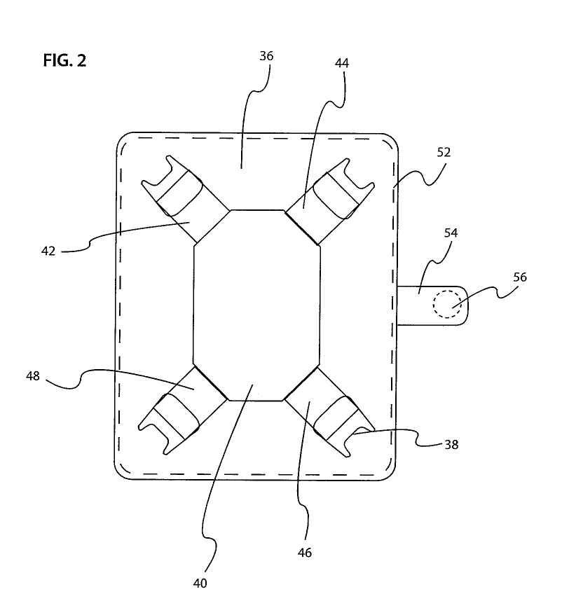

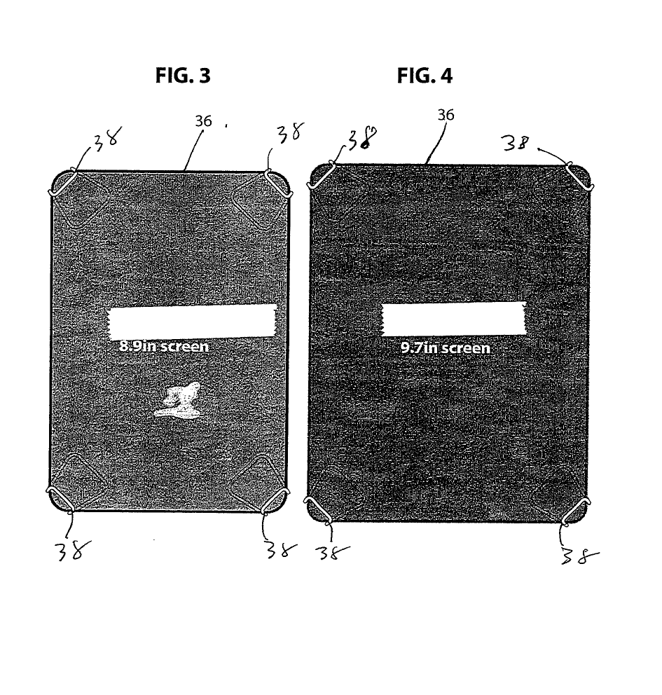

FIGS. 3 and 4 are top plan views of the holder 36 of FIG. 1, illustrating the adjustable feature whereby tablet-type computers (or other devices) of various sizes can be gripped with the corner gripping devices 38 of the holder 36 without configuring the snug retention provided by the elastic bands 42, 44, 46, 48 (shown in FIG. 2), and by the adjustable retention provided by the gripping devices 38 as illustrated in FIGS. 12 and 13, for example.

The combination of elastic bands 42, 44, 46, 48 and gripping devices 38 allow the accommodation of different size tablet devices, ranging in diagonal screen dimensions between 5 inches and 12 inches, with a single universal case. Commonly found tablet devices have diagonal screen dimensions of 5 inches, 7 inches, 9 inches, 10 inches or 12 inches, each of which are easily accommodated by the present invention. The present invention can accommodate diagonal screen sizes intermediate to the screen dimensions listed above as well. Thus, the present invention is a singular case configured to accept any arbitrarily dimensioned mobile tablet device between the sizes of 5 inches and 12 inches, and having a generally rectangular shape.

FIGS. 5-11 are perspective views of the corner gripping devices of FIGS. 1 and 2, illustrating the capability of such devices to snugly certain electronic devices of various thicknesses, due primarily by their open configuration and dimensions as shown. Such gripping devices are shown as metal wire-like devices, but can preferably be made of a softer flexible and resilient material such as plastic, i.e., nylon, polyethylene, polypropylene, or the like. Alternatively, the gripping devices may be formed of elastic materials formed into loops configured to wrap around corners of a tablet device.

Referring to FIGS. 12 and 13, the gripping devices 38 of FIGS. 5-11 are shown in side elevational views, gripping electronic tablet devices of various thicknesses. For example, FIG. 12 illustrates the grip on a thicker tablet computer, while FIG. 13 illustrates the grip on a thinner tablet computer, without loss of retention, due to the unique dimensions, configuration, shape and wire-like structure of the gripping devices.

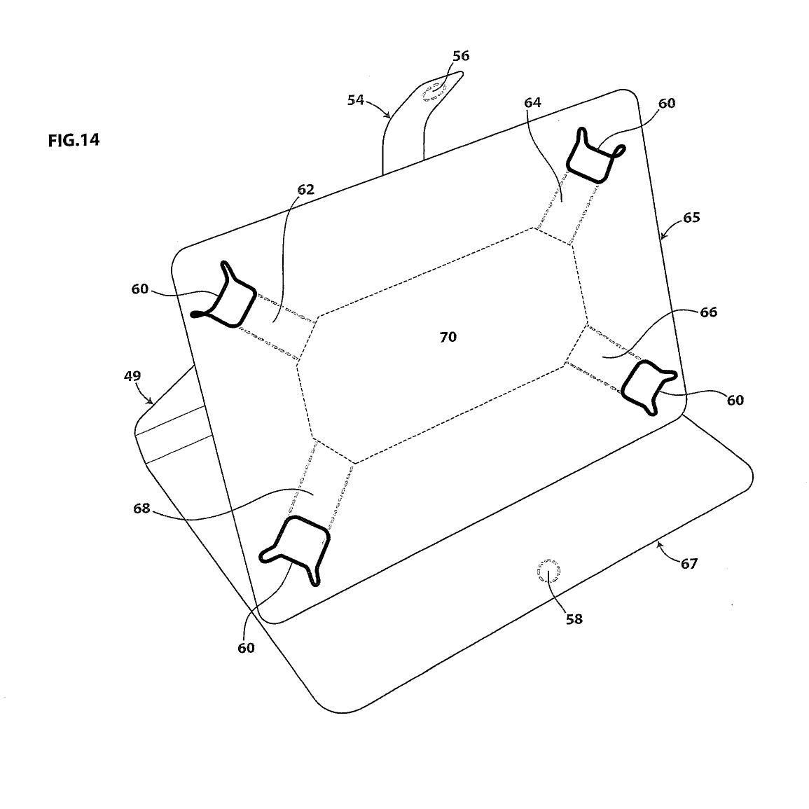

FIG. 14 is a perspective view of an alternative embodiment of the invention, wherein alternatively shaped corner gripping devices 60 are somewhat similar to the devices of FIGS. 5-13, but are slideably positioned in grooves provided in the cover material of the holder 65. Elastic straps (or bands) 62, 64, 66, 68 are respectively attached to the gripping devices and hidden from view by the outer fabric or vinyl or leather covering. The elastic straps are stretched or otherwise attached to a center section 70 of vinyl, leather or the like. Center section 70 can also be made of “PE” board for example. The center section 70 is attached to the outer fabric layer by stitches. In other respects the holder is attached to the cover by stitching 61 of otherwise as in the previous embodiments. Holder 65 is attached by stitches to cover 66 so as to be foldable and capable of positioning the holder in an upright orientation with a portion of the case forming a base 67.

While the gripping devices 60 are described above as being similar to the gripping devices shown in FIG. 5-13, the gripping devices 60 in the embodiment shown in FIG. 14 may also be formed of elastic material, such as rubber for example. The elastic material forming the gripping devices 60 may be integrally formed with the elastic straps 62, 64, 66, 68. For example, the elastic straps 62, 64, 66, 68 may be formed as loops with both ends attached to the center section 70, such that the portions of the elastic straps elastic straps 62, 64, 66, 68 between both ends forms the gripping devices 60.

Also, the elastic material may form a unitary body having the gripping devices 60 at each of four corners with the central area of the unitary body forming the center section 70. In this configuration, the elastic straps 62, 64, 66, 68 may or may not be present between the gripping devices 60 and the center section 70.

In the context of the present invention, the term loop is understood to refer to any structure in which two opposing ends are anchored to a common surface in order to form a central opening encircled by the structure. The loop need not be circular in shape, but rather may have a semi-circular, rectangular, triangular or polygonal cross-section as well, with the central space bounded by the perimeter of the shape being void.

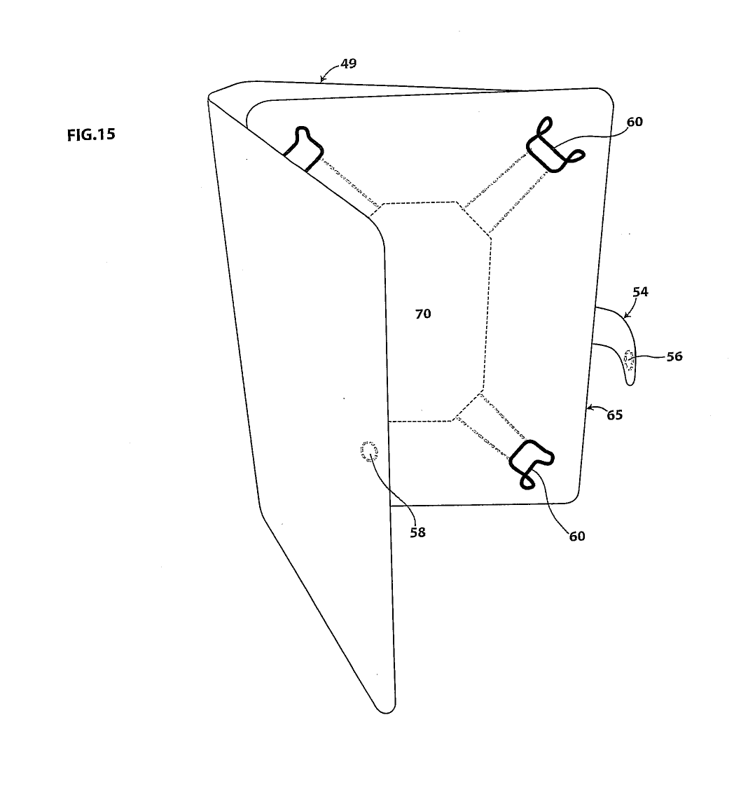

FIG. 15 illustrates the holder and cover of FIG. 14 in a partially opened condition.

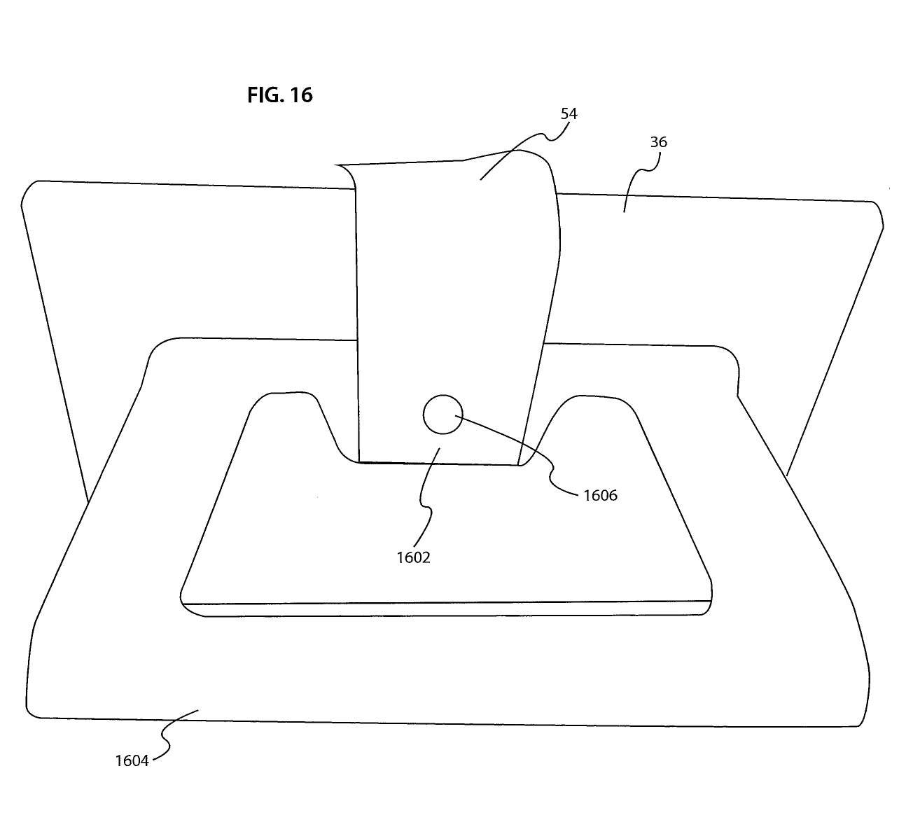

In an embodiment of the present invention the holder shown in FIG. 2 is attached to a swivel assembly 1602 as shown in FIG. 16. The swivel assembly can be integrally formed with the cover 1604 or attached to the cover 1604 by stitching or gluing, for example. The swivel assembly provides a pivot point 1606 about which the holder 36 rotate between a landscape and portrait orientation when placed in the upright viewing position. The holder 36 is attached to the cover 49 by way of the pivot point 1606.

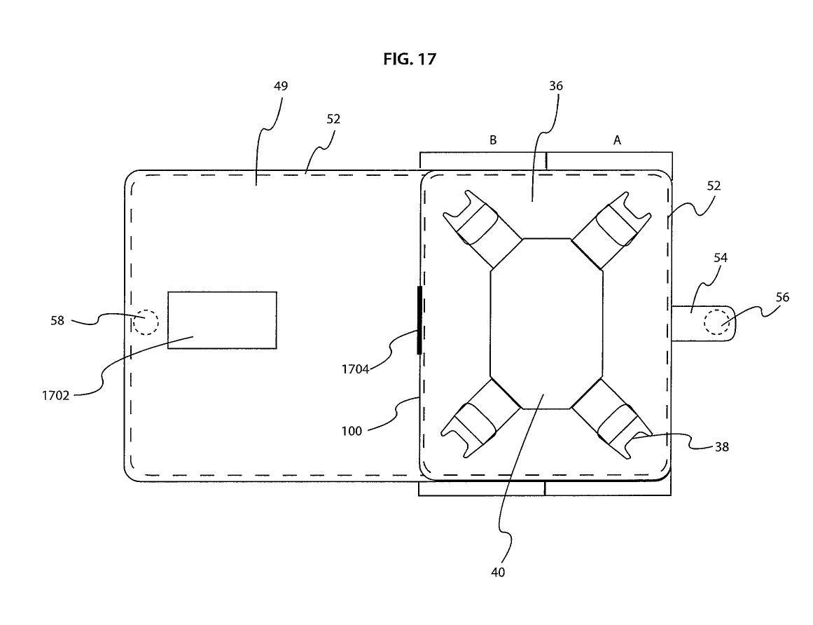

In an embodiment of the present invention, shown in FIG. 17, includes hook-and-loop assemblies generically referred to as Velcro™ such that the debossed impressions 50 of FIG. 1 are replaced with a loop portion 1702 that are compatible with hook portion 1704. The hook portion 1704 is provided at a lower edge 100 of the holder 36 such that when the holder is placed in an upright viewing orientation, hooks of the hook portion 1704 holdingly engage with loops of the loop portion 1702 placed on the interior surface of the cover 49. The hook portion 1704 may disposed on more than one side edge of the holder 36 in order to allow upright viewing of the tablet in both landscape and portrait orientations.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. A case configured to hold a tablet mobile device, the case comprising:
a cover member;
a mobile device holding member attached to the cover member at least at one point of a rear face of the mobile device holding member;
a plurality of gripping devices configured to engage each corner of the tablet mobile device respectively; and
a center section joining each gripping device at respective corners of the center section.

2. The case as in claim 1, wherein the cover member includes a set of debossed impressions on an inside surface thereof, the debossed impressions being configured to hold a lower edge of the mobile device holding member such that the cover member and mobile device holding member form a triangular profile.

3. The case as in claim 1, further comprising a pivot assembly attaching the mobile device holding member to the cover member at the at least one point, the pivot assembly being configured to allow the mobile device holding member to rotate about a central axis of the pivot assembly between a landscape orientation and a portrait orientation with respect to the case member.

4. The case as in claim 1, wherein the plurality of gripping devices are formed of an elastic material, and integrally formed at a region of respective elastic straps, the gripping devices are shaped as loops.

5. The case as in claim 7, wherein the respective elastic straps are configured as loops having a first end and a second end joined to the center area of the mobile device holding member, respective gripping devices being formed by a region of the respective elastic strap between the first end and the second end.

6. The case as in claim 1, wherein the case is configured to accommodate any generally rectangular shaped tablet mobile device having a diagonal screen dimension between 5 inches and 12 inches.

7. The case as in claim 1, wherein the case is configured to accommodate any generally rectangular shaped tablet mobile device having a diagonal screen dimension between 7 inches and 10 inches.

8. A case configured to hold a tablet mobile device, the case comprising:
a cover member;
a mobile device holding member attached to the cover member at least at one point of a rear face of the mobile device holding member;
a plurality of gripping devices configured to engage each corner of the tablet mobile device respectively; and
a plurality of elastic straps, each elastic strap joined to a respective gripping device and at least one end attached to a center area of the mobile device holding member.

9. The case as in claim 8, wherein the cover member includes a set of debossed impressions on an inside surface thereof, the debossed impressions being configured to hold a lower edge of the mobile device holding member such that the cover member and mobile device holding member form a triangular profile.

10. The case as in claim 8, wherein the case further comprises a hook-and-loop assembly, a loop portion of the hook-and-loop assembly being disposed on an inside surface of the cover member, and a hook portion of the hook-and-loop assembly being disposed on at least one edge of the mobile device holding member, the hook portion being configured to holdingly engage with the loop portion such that the cover member and mobile device holding member form a triangular profile.

11. The case as in claim 8, further comprising a pivot assembly attaching the mobile device holding member to the cover member at the at least one point, the pivot assembly being configured to allow the mobile device holding member to rotate about a central axis of the pivot assembly between a landscape orientation and a portrait orientation with respect to the case member.

12. The case as in claim 8, wherein the plurality of gripping devices are formed of a metallic material, and shaped as raised loops.

13. The case as in claim 8, wherein the plurality of gripping devices are formed of a plastic material, and shaped as raised loops.

14. The case as in claim 8, wherein the plurality of gripping devices are formed of an elastic material, and integrally formed at a region of respective elastic straps, the gripping devices are shaped as loops.

15. The case as in claim 14, wherein the respective elastic straps are configured as loops having a first end and a second end joined to the center area of the mobile device holding member, respective gripping devices being formed by a region of the respective elastic strap between the first end and the second end.

16. The case as in claim 8, wherein the case is configured to accommodate any generally rectangular shaped tablet mobile device having a diagonal screen dimension between 5 inches and 12 inches.

17. The case as in claim 8, wherein the case is configured to accommodate any generally rectangular shaped tablet mobile device having a diagonal screen dimension between 7 inches and 10 inches.
